(19) United States
(12) Patent Application Publication
(10) Pub. No.: US 2008/0277838 A1
(43) Pub. Date: Nov. 13, 2008

(54) Apparatus and Method For Lining Conduits

(76) Inventors: Brian Maxwell Hassen, Ardross (AU); Neil Deryck Bray Graham, Canning Vale (AU)

Correspondence Address: HOGAN & HARTSON LLP, ONE TABOR CENTER, SUITE 1500, 1200 SEVENTEENTH ST, DENVER, CO, 80202, US

(21) Appl. No.: 11/916,429

(22) PCT Filed: Jun. 5, 2006
(86) PCT No.: PCT/AU2006/000764

§ 371 Date: Jun. 25, 2008

(30) Foreign Application Priority Data
Jun. 3, 2005 (AU) 2005902881
Sep. 5, 2005 (AU) 2005904856

(51) Int. Cl. B29C 70/68

(52) U.S. Cl. 264/511; 156/423

(57) ABSTRACT

Apparatus for, and a method of, lining an internal surface (13) of a conduit (15). The lining typically comprises a tube structure (17) which is applied to the internal surface (13) of the pipeline (15), the tube structure being impregnated with a resin which upon curing forms, together with the tube structure, a composite structure which provides the lining. The tube structure (17) is applied to the internal surface (13) of the pipeline (15) by way of an eversion process. The apparatus (10) comprises a body (24) having a portion (63) confronting the everting tube structure (17) to in combination with an everting portion (33) of the tube structure (17) define a space (68) within the pipeline (15) for receiving the resin. The body (24) incorporates a ring structure (120) presenting a contact surface (125) against which the everting portion (33) engages as it moves towards the internal surface (13) of the conduit (15). Contact between the contact surface (125) and the everting portion (33) of the tube structure (17) assists in achieving wetting out of a layer of resin-absorbent material incorporated in the tube structure before it is presented to the inner surface (13) of the pipeline (15). The contact surface assists il spreading the curable resin and also in driving it into the fibres of the resin-absorbent material, as well as removing air from between the fibres. A vent system (140) is provided for removal of air from within the space (68). Further, means (110, 112) are provided for recirculating resin material which leaks from the space (68).

### FIELD OF THE INVENTION

This invention relates to an apparatus for, and a method of, lining ducts and other conduits.

### BACKGROUND ART

The invention has been devised particularly, although not solely, for internally lining fluid flow conduits and is applicable to both gravity flow pipelines, such as pipeline for sewer and stormwater drainage, and pressurized pipelines such as water and gas pipelines.

The invention may be used for the renovation of existing pipelines and other conduits in various states of deterioration, with problems ranging from impaired hydraulic performance to partial or complete loss of structural integrity resulting in a total failure to contain the fluids within, or stop the ingression of fluids from without, the pipe. Additionally, the invention may be used to line existing pipelines and other conduits in order to extend the service life thereof. Similarly, the invention may be used to line new pipelines and other conduits in order to provide longevity in terms of service life.

The lining may comprise a tube applied to the internal surface of the conduit, the tube being impregnated with a resin which upon curing forms a composite structure with the tube to provide a lining, or alternatively an agent applied to the internal surface, with the agent being pressed into contact with the internal surface by a bladder structure configured as a tube, the bladder structure being subsequently withdrawn after the agent has cured or otherwise hardened to provide a lining.

The invention is a development of proposals disclosed in earlier international applications PCT/AU01/00563 and PCT/AU2003/001131, both of which belong to the present applicant.

The proposals disclosed in the aforementioned applications relate to lining conduits involving installation of a liner as a tube which is everted into the conduit. The tube comprises a layer of resin absorbent material. As the tube is everted, uncured resin is applied to the everting face of the tube to impregnate the layer of resin absorbent material which is then presented to the surface of the conduit. The everted tube is held in place by fluid pressure within the tube until the resin cures sufficiently to form a lining on the internal surface of the conduit. The lining so formed may be rigid, semi-rigid or flexible.

The tube unfurls from a folded condition as it everts and the layer of resin absorbent material is exposed to the uncured resin during the eversion process. As the tube unfurls, the period of exposure to the resin varies; for certain sections of the everting tube, there is very little time available for contact between the layer of resin absorbent material and the uncured resin to achieve wetting out of the layer of resin absorbent material before it is presented to the surface of the conduit. This can be disadvantageous, as the exposure time of the layer of resin absorbent material to the resin can determine the effectiveness of the wet out.

Further, air can be trapped in the layer of resin absorbent material. Where the layer of resin absorbent material comprises fibres (as is typically the case), air can be trapped in the fibre bundles, which are likely to be in a more compacted condition as a result of the tube being folded. The compacted nature of the fibres and also air trapped within the fibre bundles inhibit the wetting out process.

It is against this background that the present invention has been developed.

### DISCLOSURE OF THE INVENTION

According to a first aspect of the invention there is provided apparatus for lining an internal surface of a conduit, the apparatus comprising a body having a portion for confronting an everting tube structure to in combination with an everting portion of the tube structure define a space within the conduit for receiving an agent material delivered into the space, and means presenting a contact surface against which the everting portion engages as it moves towards the internal surface of the conduit.

Preferably, the contact surface extends entirely around the everting portion of the tube structure.

The contact surface may be defined by a structure defining an opening through which the everting portion of the tube structure passes in sliding contact therewith.

The structure may define at least one further opening and contact surface.

Preferably, the structure comprises a ring defining the or each opening and the associated contact surface. The structure may, for example, comprise three rings in which case there would be three openings each defined by one of the rings.

The structure may further comprise a support for supporting the or each ring.

The rings may be fixed with respect to each other or they may be selectively movable one relative to the other for varying the spacing therebetween. Further, the rings may be movable as an assembly between an operative condition in which they function as described and an inoperative condition in which they are retracted such as when not required or where the apparatus is being transported.

Preferably, the or each opening corresponds in shape to the cross-sectional shape of the conduit. Where, for example, the conduit is of circular cross-section, the or each opening is preferably also circular. If the conduit is of non-circular cross-section, the or each opening is preferably then of a corresponding non-circular shape.

Preferably, the contact surface is arcuate in cross-section. The or each ring may be circular in cross-section to define the circuate contact surface.

Preferably, the or each opening is spaced from said portion of the body.

The or each opening may be of a size smaller than the size of the approaching everting portion of the tube structure to thus cause the everting portion to turn inwardly in order to pass through the opening prior to passing through the opening, the everting portion can expand into the conduit. In this manner, the tube structure can be unfurled and folds therein opened prior to entering the opening. The ring structure can then be employed to drive out any air entrapped in the tube structure and spread the agent material evenly around the space, forming an annulus of agent material around the everting portion. More particularly, where the tube structure comprises resin absorbent material containing fibres, the tube structure is forced to move in a number of directions, opening and closing fibres within the resin absorbent material and also driving out the air trapped therein.

Preferably, the tube structure is delivered to, and pulled along, the conduit in a collapsed condition and is everted from that condition. In one embodiment, in the collapsed condition, the tube structure is in a folded configuration having two opposed longitudinal side portions with re-entrant folds therebetween.

With eversion of the tube structure, there is created an inner tube portion and an outer tube portion, with the two portions being joined by the everting portion.

Preferably, an inflation chamber is defined within the tube everted structure, and an inflation fluid (such as air) is introduced into the inflation chamber so as to urge the everted tube structure outwardly in order to position it in contact with the internal surface of the conduit.

It is the inflation pressure that causes the tube structure to evert as the body moves along the conduit.

The combination of the inflation pressure and the need for the everting portion of the tube structure having to turn inwardly in order to pass through the opening in the structure defining the surface may assist in removal of at least some folds, as well as creasing and wrinkling, existing in the everting portion as the tube structure unfurls from a collapsed condition.

The agent material may comprise a curable resin. The curable resin may comprise a mixture of a resin and a catalyst. The resin and the catalyst may be brought together and mixed during the liner installation process. In this regard, the installation structure may incorporate a mixing chamber in which supplies of the resin and catalyst are introduced. The mixing chamber may comprise a spiral mixing chamber.

The tube structure may comprise a layer of resin absorbent material or a thermoplastic, or rubber membrane for lining the conduit (with or without an absorbent material adhered to it). The resin absorbent material may comprise fibreglass fabric. The fibreglass fabric may fully or partly impregnated, or dry.

Further, the tube structure may comprise a single tube or a plurality of tubes disposed one within another. In the latter case, one tube may comprise the liner for the conduit and the other tube or tubes may be used for inflation to urge the liner tube into engagement with the internal surface of the conduit.

Contact between the contact surface and the everting portion of the tube structure assists in achieving wetting out of the layer of resin absorbent material before it is presented to the inner surface of the conduit. This is because the contact surface assists in spreading the curable resin and driving it into the-fibres, as well as removing air from between the fibres, as the everting portion slides over the contact surface. The contact surface in effect wipes, compacts, and works the fibres of the everting portion to work the curable resin into the resin absorbent material and also remove air therefrom.

A vent system may be provided for removal of air from within said space.

The vent system may comprise a venting path extending from said space.

The venting path may comprise a first vent line having an intake end section adapted to locate between the internal surface of the conduit and the everting tube. In this regard, the intake end section may comprise a snorkel which extends into the region between the everting tube and the internal surface of the conduit at the upper end section thereof. Additionally, or alternatively, the venting path may comprise a second vent tine communicating with a zone in said space. The second vent line may have an intake manifold section accommodated in said space. The intake manifold section may have a plurality of intake ports opening onto said space. The manifold may be of acuate configuration and positioned closely adjacent the surface. The intake manifold section may be incorporated in at least one of the rings. In this regard, said at least one ring may incorporate an air flow passage which opens onto the contact surface defined by the ring at the intake ports. With this arrangement, air expelled from the tube structure as it passes over said contact surface can escape via the second vent line.

The vent system may further comprise a chamber functioning as a venting chamber with which the venting path communications. The venting chamber is adapted to receive vented air from the space. Typically, the vented air is mixed with agent material which can pass along the venting path to the venting chamber. The mixture of vented air and the agent material can separate in the venting chamber.

Means may be provided for returning agent material separated and collected within the venting chamber to the space. Thus, there is recirculation of the collected agent material.

The means for returning agent material collected in the venting chamber may comprise a first return line and a first pump. The pump may comprise a diaphragm pump (such as a bilge pump).

The pump may be operable in response to a prescribed quantity of agent material being collected in the venting chamber. For example, a control means may be provided for determining when a prescribed quantity of agent material has been collected in the venting chamber and effecting operation of the pump. The control means may comprise a float switch within the venting chamber responsive to the level of agent material collected therein.

Preferably, the body comprises a first (trailing) seal for sliding engagement with the internal surface of the conduit, the first seal confronting the space, and a holding chamber adjacent the trailing end of the body, one end of the holding chamber being defined by the first seal, the holding chamber applying agent material contained therein to the internal surface of the conduit.

The agent material contained within the holding chamber may be received therein through leakage of such material from said space past the first seal.

The other end of the holding chamber may be defined by a second seal for sliding engagement with the internal surface of the conduit.

The body may comprise one or more further holding chambers disposed one adjacent another with respective sliding seals separating adjacent chambers.

Thus, there may be a single holding chamber, or alternatively a series of holding chambers, ahead of said space (with respect to the direction of travel of the body along the conduit).

Preferably, the portion of the body for confronting the everting tube structure comprises a contact face against which the tube structure everts. The contact face may be configured to conform to, and guide, the everting portion of the tube structure as it turns between the inner tube portion and the outer tube portion.

Preferably, the contact face defined by a pressure plate.

The pressure plate provides a surface for the tube structure to exert force upon and against which to work the fibres of the tube structure. The pressure plate separates the space from the direct force of the everting tube structure but maintains hydraulic contact between the space and the face of the everting tube structure to allow the tube structure to be wet by the agent material. The agent material is preferably delivered to the space from a source by a delivery system.

A plurality of apertures may be provided in the pressure plate, the apertures opening onto the contact face by way of ports incorporated in the contact face to provide the hydraulic connection between the space and the wall of the everting tube structure. With this arrangement, the everting tube structure wipes over the contact face and so is exposed to agent material delivered from the space. The agent material from the space may also travel back down the tube structure to fill and wet the tube structure as it approaches the pressure plate.

The tube structure may comprise a single tube or a plurality of tubes disposed one within another. In the latter case, one tube may comprise the liner for the conduit and the other tube or tubes may be used for inflation to urge the liner tube into engagement with the internal surface of the conduit.

The apparatus may further comprise an accumulation chamber for collecting material migrating from the space and the holding chambers.

Preferably, the chamber functioning as the venting chamber also functions as the accumulation chamber. In other words, there is a common chamber performing the functions of both the venting chamber and the accumulation chamber. With such an arrangement, there is a common location for the collected agent material and only one pump and return line is required for returning agent material accumulating in the common chamber to the space.

The common chamber is preferably located ahead of the series of holding chambers, or alternatively ahead of the single holding chamber (as the case may be).

The common chamber may be defined between the respective sliding seal of an adjacent holding chamber and a further sliding seal provided on the body.

A further accumulation chamber may be provided for collecting any agent material migrating from the common chamber. Further a return means may be provided for returning the collected material.

The means for returning agent material collected in the further accumulation chamber may comprise a second return line and a second pump.

The second pump may be operable in response to a prescribed quantity of agent material being collected in the further accumulation chamber.

The apparatus may further comprise an installation structure adapted to be conveyed along the conduit.

The installation structure may be caused to move along the conduit in any appropriate way, such as for example by application of a driving force thereto. The driving force may involve a towing force applied by way of a tow line or pressure applied to the body through the everting tube (arising from the presence of an inflation fluid with the tube), or a combination thereof.

The installation structure may be of articulated construction, comprising at least two modules connected together by a link extending therebetween. Preferably, the link provides a substantially inextensible and incompressible connection between the modules while allowing lateral movement therebetween. The link may, for example, comprise a rigid link pivotally connected at its ends to the modules.

The second module may comprise means for applying a retarding force for controlling the rate of advancement of the installation structure along the conduit. In this regard, the second module may comprise a brake sled in friction engagement with the internal surface of the conduit. Means may be provided for selectively varying frictional engagement between the brake sled and the internal surface of the conduit.

There may be third module disposed between the first and second modules, whereby the three modules are linked in series one to another with adjacent modules being interconnected by a fink connected therebetween. The links between the various modules allows articulation therebetween while transferring driving and braking forces from one module to another.

The third module may accommodate the first and second return pumps.

The second module comprising the brake sled may be the leading module (with respect to the direction of travel of the installation structure along the conduit), and the third module may incorporate means for rolling engagement with the internal surface of the conduit to prevent “jack-knifing” or other excessive lateral deflection of the articulated installation structure when under braking.

Data logging and video equipment may be incorporated into the installation structure. Further, there may be a load cell for detecting the load applied to the installation structure when it is being towed or otherwise conveyed along the conduit.

According to a second aspect of the invention there is provided a method of lining a conduit utilising an apparatus according to the first aspect of the invention.

According to a third aspect of the invention there is provided a method of lining the internal surface of a conduit using a tube structure, the method comprising: everting the tube structure to provide an inner tube portion, an outer tube portion and an everting portion therebetween; exposing the everting potion to an agent material contained in a space confronting the everting portion; and contacting the everting portion with a contact surface as it moves towards the internal surface of the conduit.

According to a fourth aspect of the invention there is provided a method of lining the internal surface of a conduit using a tube structure, the method comprising: everting the tube structure to provide an inner tube portion, an outer tube portion and an everting portion therebetween; exposing the everting potion to an agent material contained in a space confronting the everting portion; and passing the everting portion through an opening defined by means presenting a contact surface against which the everting portion is in sliding contact as it passes through the opening.

There is also provided apparatus for lining an internal surface of a conduit, comprising a body having a trailing end for confronting an everting tube structure to in combination with an everting portion of the tube structure define a space with the conduit for receiving an agent material delivered into the space, an accumulation chamber for collecting material migrating from the space, and means for returning agent material collected within the accumulation chamber to the space.

Further, there is also provided a method of lining a conduit utilising an apparatus defined in the immediately preceding paragraph.

### BRIEF DESCRIPTION OF THE DRAWINGS

The invention will be better understood by reference to the following description of several specific embodiments thereof as shown in the accompanying drawings in which.

FIG. 1 is a schematic side view of apparatus according to a first embodiment for installing a liner on the internal surface of a conduit;

FIG. 2 is a schematic end view of a module forming part of the apparatus;

FIG. 3 is a schematic fragmentary side view of the apparatus;

FIG. 4 is a schematic sectional view illustrating the everting portion of the liner passing through a ring structure;

FIG. 5 is a fragmentary view, on an enlarged scales showing the ring structure acting on the everting portion of the liner;

FIG. 6 is an elevational view of a ring forming part of the ring structure;

FIG. 7 is a schematic fragmentary side view of apparatus according to a second embodiment for installing a liner on the internal surface of a conduit; and

FIG. 8 is a schematic fragmentary side view of apparatus for installing a liner on the internal surface of a conduit, the apparatus being a variation of the first embodiment.

### BEST MODE(S) FOR CARRYING OUT THE INVENTION

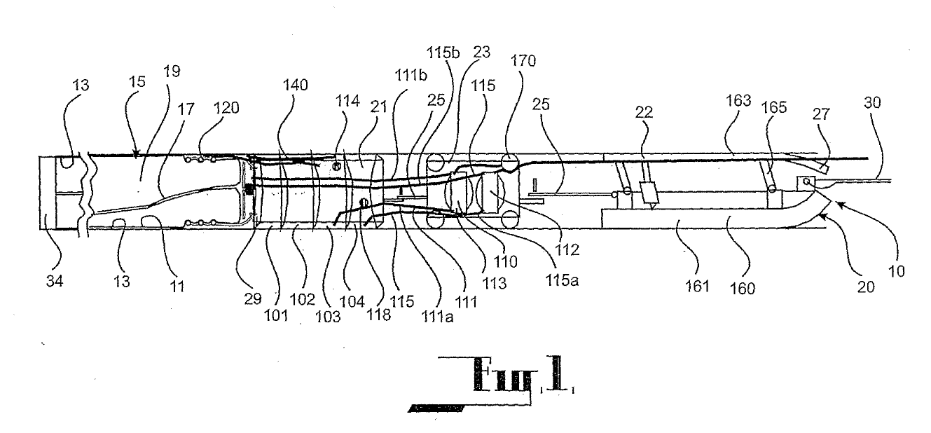

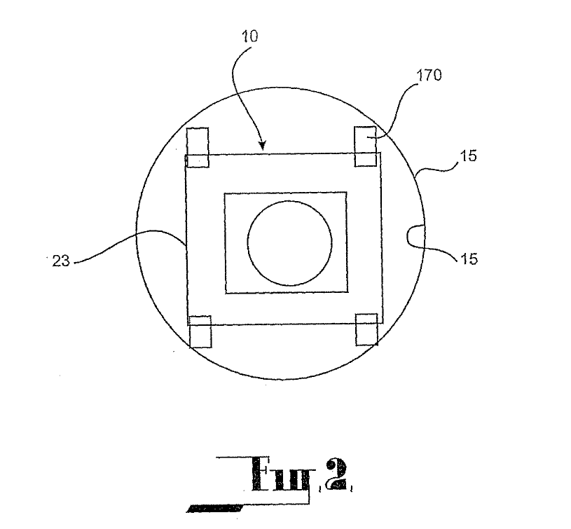

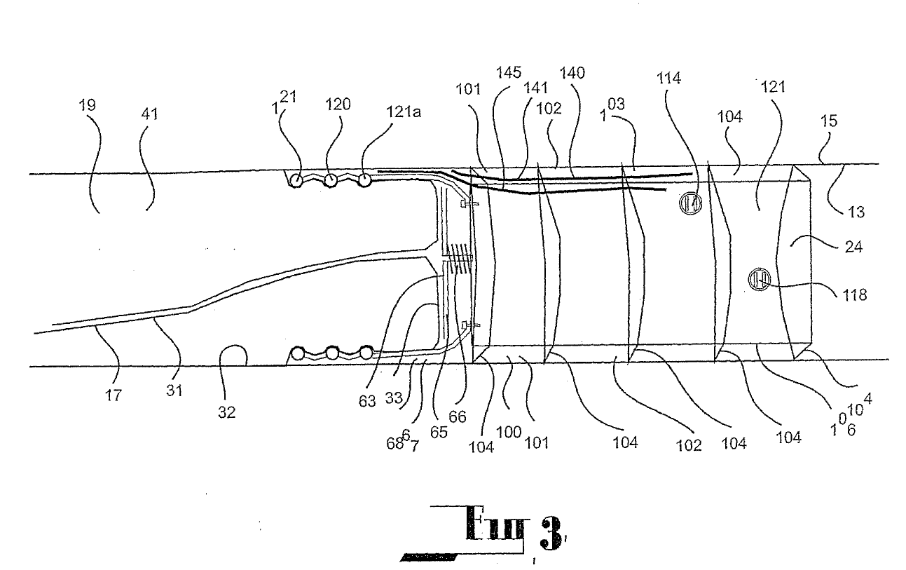

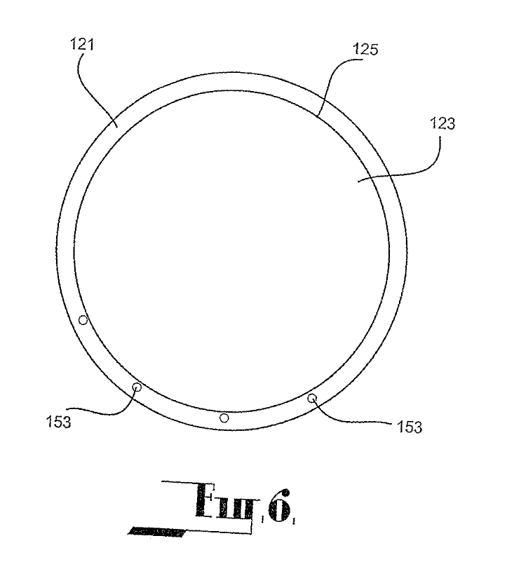

Referring to FIGS. 1 to 6, the first embodiment is directed to apparatus 10 for installing a liner 11 onto the interior surface 13 of a conduit in the form of a pipeline 15. The liner 11 provides a hermetically sealed barrier that is resistant to both corrosion and wear.

The liner 11 is in the form of an everted tube structure 17. Prior to eversion, the tube structure 17 comprises a first tubular layer (not shown) of a resin absorbent material such as fibreglass fabric and a second tubular layer (not shown) providing a membrane. The first layer may be fully or partly impregnated with resin, or alternatively it may be dry. The second layer functions as an internal sealing membrane for exposure to an inflation force and driving force imposed on the tube structure during the installation procedure, as will be explained later

Prior to eversion of the tube structure 17, the first layer is innermost and the second layer is outermost to surround the first (inner) layer. The membrane material providing the second (outer) layer is selected according to the demands placed on the liner 11 within the pipeline 15. For example, where abrasion and wear resistance is required, the second layer may be formed of polypropylene. In other cases, the second layer may be formed of polyester (Mylar), nylon, urethane, rubber or other material appropriate for the intended application.

In still other cases, the second layer may be formed of a low-cost material (for example, polyethylene) and be removable leaving resin rich fibreglass as the surface in contact with the fluids of the pipeline.

Upon eversion, the first layer is turned outwardly and presented to the interior surface 13 of the pipeline 15. As will be explained in detail later, a curable resin is applied to the first layer prior to its application onto the interior surface 13 of the pipeline 15. An inflation fluid is delivered into the interior 19 of the everted portion of the tube structure 17 to maintain the tube structure in intimate contact with the interior surface 13 of the pipeline 15 until the resin has cured, whereupon the resin and fibreglass fabric combine to provide a rigid composite structure, or alternatively a flexible or semi rigid liner which lines the pipeline 15. The second layer, which provides the membrane, is on the inner face of the composite structure and in contact with subsequent fluid flow along the pipeline.

The curable resin may comprise an epoxy, vinyl, polyester, urethanes curable rubber or acrylic resin such as methyl methacrylate. The curable resin may be aerated in certain applications.

The apparatus 10 comprises an installation structure 20 which is movable along the pipeline 15. The installation head 20 is adapted to be progressively moved along the pipeline 15 during installation of the liner 11.

The installation structure 20 is of articulated construction, comprising first, second and third modules 21, 22, 23. Adjacent modules 21, 22, 23 are pivotally connected one to another by way of a rigid link 25 extending therebetween.

The structure 20 has a leading end 27 and a trailing end 29. In this embodiment, the structure 20 is adapted to be pulled through the pipeline 15 by way of a tow line 30 connected to the leading end 27 and extending to a station (not shown) located exteriorly of the pipeline 15.

The tube structure 17 is delivered to, and pulled along, the pipeline 15 in a flattened or collapsed condition and is everted from that condition. In the flattened or collapsed condition, the tube structure 17 has two opposed longitudinal side portions and folds therebetween.

With eversion of the tube structure 17, there is created an inner tube portion 31, an outer tube portion 32, and an everting portion 33 therebetween.

One end of the tube structure 17 is attached to a rigid installation duct 34 positioned adjacent the inlet end of the pipeline 15. Typically, the tube structure 17 is connected to one end of the duct 34 by way of a clamping collar (not shown) which extends around the tube structure and sealingly connects it to the end of the duct.

An inflation chamber 41 is defined within the everted structure 17.

An inflation fluid (such as air) is introduced into the inflation chamber 41 so as to urge the everted tube structure 17 outwardly in order to position it in contact with the interior surface 13 of the pipe 15 to which it is bonded while the resin applied thereto sets.

The inflation pressure causes the tube structure 17 to evert as the installation structure 20 moves along the pipeline 15.

The first module 21 of the installation structure 20 comprises a body 24 having a contact face 63 at the trailing end thereof against which the tube structure 17 everts. The contact face 63 is configured to conform to, and guide, the everting portion 33 of the tube structure 17 as it turns between the inner tube portion 31 and the outer tube portion 32. The contact face 63 is defined by a pressure plate 65. A resin chamber 67 is located in the body 23 adjacent the pressure plate 65.

The pressure plate 65 provides physical boundary for the resin chamber 67 and separates the hydraulics of the resin chamber from the everting tube structure 17. Resin delivery lines (not shown) are provided for delivering the curable resin from a source (not shown) to the resin chamber 67.

The pressure plate 65 is supported on ram 66. The ram 66 can be extended or retracted and is so doing is adapted to regulate the supply of resin to chamber 67.

A plurality of apertures (not shown) are provided in the pressure plate 65. The apertures open onto the contact face 63 by way of ports (not shown) incorporated in the contact face 63. With this arrangement, the everting tube structure 17 wipes over the contact face 63 and so is exposed to resin delivered from the resin chamber 67. The resin from the resin chamber 67 also flows into a volume defined by space 68 bounded by the pressure plate 65 and the everting tube structure 17 to ensure that the everting tube structure is fully exposed to the resin, and travels back down the tube structure to fill and wet the tube structure as it approaches the pressure plate 65.

In this embodiment, the separation of the resin chamber 67 from the force of the everting tube structure 17 driving and pressing against the trailing end 29 of the installation structure 20 means that the resin pressure need only be enough to fill the depth of the chamber and that this is consistent and can be monitored. Also the content of resin in the chamber can be monitored in various means to ensure that all air is purged from the resin volume.

The body 24 incorporates a plurality of holding chambers 100 disposed axially therealong. In this embodiment, there are two such holding chambers 101, 102.

Each chamber 100 is of annular configuration and is defined between two spaced apart annular wiper seals 104 and an inner wall 106. The outer periphery of each chamber 100 is exposed directly to the interior surface 13 of the pipeline 15.

In this embodiment, each chamber 100 is adapted to receive resin from the resin supply for the purposes of depositing a layer of resin onto the interior surface 13 of the pipeline 15 prior to application of the liner 11 in position. This further ensures that there is adequate resin for the purpose of wetting out the fibreglass fabric layer of the tube structure 17.

The chambers 100 operate at different resin pressures, chamber 101 being at a higher resin pressure than chamber 102. The decreasing resin pressure extending from chamber 101 to chamber 102 reduces the likelihood of resin leakage from the installation head 21. Any leakage from chamber 101 (which is at the higher resin pressure) can either be rearwardly towards the everting tube structure 17 (where resin is required in any event) or forwardly into chamber 102 (which is at reduced pressure relative to chamber 101).

The wipe seals 104 extend rearwardly and outwardly with respect to the direction of travel of the installation head 21, as is apparent from the drawing. With this arrangement, the wiper seals 104 are biased outwardly into sealing engagement with the interior surface 13 of the pipeline under fluid pressure within the respective chambers 100 to which the wiper seals are exposed. This is particularly advantageous in relation to the particular wiper seal confronting the resin chamber 67, as the resin pressure therein serves to urge the wiper seal outwardly into sealing engagement with the interior surface of the pipeline.

While the seals 104 have been described as being in sliding and sealing engagement with the interior surface 13 of the pipeline, it should be understood that they are more likely to be in sliding and sealing engagement with a layer of resin applied to the interior surface. The seals 104 are utillsed not only to perform a sealing function but also to perform a wiping or spreading function by applying resin to the interior surface 13. Accordingly, it is necessary for the seals 104 to accommodate the film of resin.

In this embodiment, the holding chambers 100 comprise the two chambers 101, 102. It will be appreciated that any appropriate number of chambers can be employed, as necessary. It is particularly advantageous for there to be a multitude of chambers 100, such that there is ample resin available to fill defects such as cracks and cavities in the interior surface 13 of the pipeline 15, with the series of chambers progressively filling the defects as they pass over them upon movement of the installation structure 20 through the pipeline. The chambers would be at progressively decreasing resin pressures such that any leakage from one chamber can either be rearwardly to the adjacent rearwardly disposed chamber (which is unlikely owing to the higher pressure in that chamber) or forwardly to the adjacent forwardly disposed chamber (which is more likely owing to the lower pressure in that chamber).

A chamber 103 is provided adjacent the second holding chamber 102. The chamber 103 constitutes a common chamber functioning as a venting chamber (the purpose of which will be explained later) and also as an accumulation chamber for resin.

A second accumulation chamber 104 is provided adjacent the common chamber 103.

The chambers 103, 104 are somewhat similar in construction to the holding chambers 100, in that each is of annular configuration defined between two spaced apart annular wiper seals 104 and the inner wall 106. The outer periphery of each chamber 103, 104 is exposed directly to the interior surface 13 of the pipeline 15.

In functioning as an accumulation chamber for resin, the common chamber 103 is adapted to receive surplus resin which has leaked from the second holding chamber 102. Rather than this surplus resin being wasted, there is provision for returning the surplus resin to the resin chamber 67. A first return means 110 is provided for this purpose. The first return means 110 comprises a first return line 111 and a first pump 113. The first return line 111 extends from the common chamber 103 and communicates directly with the resin chamber 67 or alternatively with a supply line delivering resin to that chamber. The first return line 111 comprises an intake section 111a leading to the pump 113 and a discharge section 111b extending from the pump.

The first pump 113 is accommodated in the third module 23 and is adapted to be operable in response to a prescribed volume of resin collecting in the common chamber 103. Sensor means 114 such as a float switch is provided within the chamber 103 for the purposes of detecting the quantity of surplus resin collected and initiating operation of the first pump 113 as necessary. Upon operation of the first pump 113, surplus resin material collected in the chamber 103 is returned to the resin chamber 67 via the first return line 111.

The second accumulation chamber 104 is adapted to receive resin which has leaked from the common chamber 103. As is the case with chamber 103, there is provision for returning the resin accumulating in the second accumulation chamber 104 to the resin chamber 67. A second return means 112 is provided for this purpose. The second return means 112 comprises a second return line 114 and a second pump 116. The second return line 115 extends from chamber 104 and communicates directly with the resin chamber 67 or alternatively with a supply line delivering resin to that chamber. The second return line 115 comprises an intake section 115a leading to the pump 116 and a discharge section 115b extending from the pump.

As is the case with the first pump 113, the second pump 116 is accommodated in the third module 23 and is adapted to be operable in response to a prescribed volume of resin collecting in the second accumulation chamber 104. Sensor means 118 such as a float switch is provided within the accumulation chamber 104 for the purposes of detecting the quantity of surplus resin collected and initiating operation of the pump 116 as necessary. Upon operation of the pump 116, surplus resin material collected in the chamber 104 is returned to the resin chamber 67 via the return line 115.

Collection and recirculation of surplus resin is particularly advantageous, as it avoids unnecessary wastage of resin material. Additionally, it avoids problems that might possibly arise in circumstances where leaking resin material could cause damage to other parts of the installation structure 20.

Attached to the body 24 is ring structure 120 against which the everting portion 33 of the tube structure 17 engages as it moves towards the interior surface 13 of the pipeline 15.

The ring structure 120 comprises a plurality of rings 121, of which there are three in this embodiment. The rings 121 are in a spaced apart relationship corresponding to the axial extent of the tube structure 17.

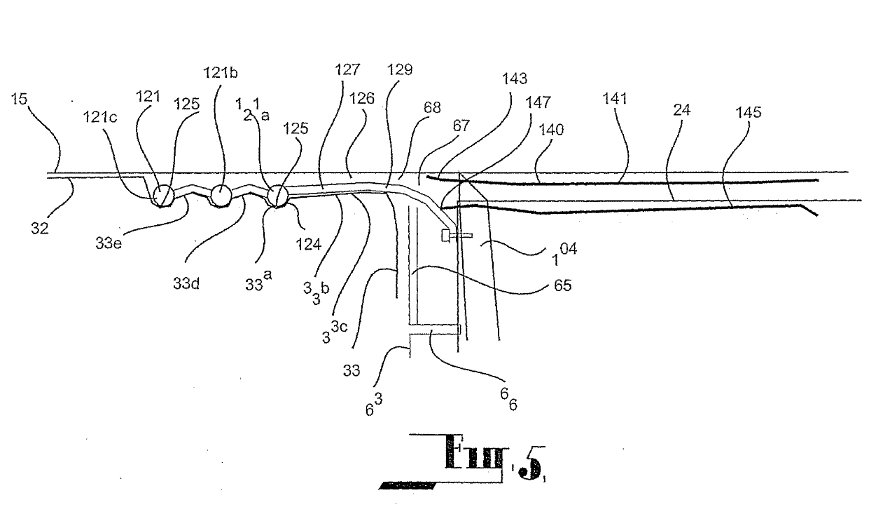

Each ring 121 defines a circular opening 123 through which the everting portion 33 of the tube structure 17 passes in sliding contact therewith. Specifically, each ring 121 presents a contact surface 125 which extends entirely around section 33a of the everting portion 33 of the tube structure 17 and against which section 33a of the everting portion 33 engages as it moves towards the interior surface 13 of the pipeline, as best seen in FIG. 5. Each ring 121 is formed of material of circular cross-section so as to present an arcuate profile to the everting portion 33 at the contact surface 125.

Each opening 123 is of a size smaller than the size of the approaching everting portion 33 of the tube structure 17 to thus cause the everting portion 33 to turn inwardly at 124 in order to pass through the opening 123. Furthermore, the ring structure 120 serves to guide the everting portion 33 as it leaves the pressure plate 65 and approaches the first ring 121a encountered. Specifically, the section 33b of the everting portion 33 between the pressure plate 65 and the first ring 121a is maintained away from the interior surface 13 of the pipeline 15, thereby creating an annular gap 126 which surrounds the everting portion 33 and which constitutes an extension to the space 68. In this ways the period of time in which resin contained in the space 68 is in contact with the everting portion 33 of the tube structure is increased considerably.

The ring structure 120 further comprises a support 127 on which the rings 121 are carried. The supports 127 comprises arms 129 which carry the rings 121 The arms 129 extend through space 68 on the outer side of the everting portion 33 and are connected to the body 24. The arms 129 are stiff yet have some flexibility in order to bounce if necessary and also deflect around any restriction that might be encountered in the pipeline 15. The combination of the inflation pressure within chamber 41 and the everting portion 33 of the tube structure turning inwardly at 124 causes a section 33c of everting portion 33 of the tube structure 17 to fully expand into the region between the ring 121a and the body 23, removing folds 130 present in the everting tube structure as it moves unfurls from a collapsed condition. The expanded section 33c of the tube structure is then contracted in order for it to pass through opening 123 in the first ring 121a. This assists in further removing folds, as well as removing any wrinkling and creasing, in the everting portion 33 as the tube structure 17 unfurls from a collapsed condition. Further, it drives air from the fibres and drives resin into the fibres. The inflation pressure within chamber 41 causes the section 33d of the everting portion 33 to expand outwardly in the region between the first ring 121a and the second ring 121b, as best seen in FIG. 5. Similarly, the inflation pressure within chamber 41 causes the section 33e of the everting portion 33 to expand outwardly in the region between the second ring 121b and the third ring 121c, also as best seen in FIG. 5. The arms 129 are configured to accommodate such expansion.

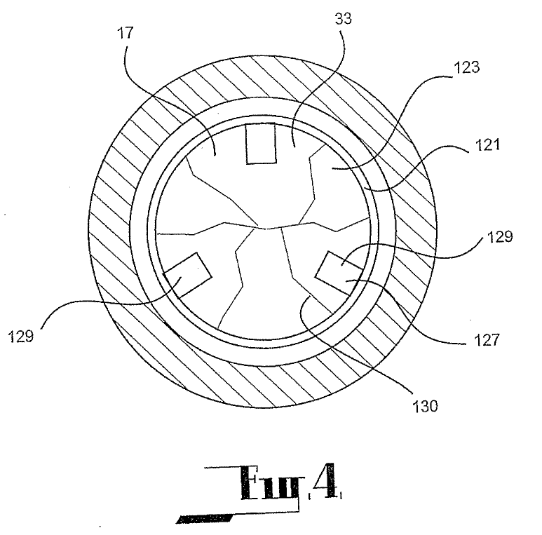

The folds 130 are depicted in FIG. 4. The folds 130 are a consequence of the tube structure 17 unfurling from the collapsed (folded) condition and their presence is undesirable as it can inhibit proper wetting out of the tube structure 17. As the tube structure 17 slides over each contact surface 125 (and more particularly the contact surface 125 defined by the first ring 121a) the folds 130 open, thereby facilitating full wetting out of the tube structure 17. In the absence of the ring structure 120, the folds would extend to the interior surface 13 of the pipeline 15, leading to incomplete wetting out and thus dry patches in the tube structure 17.

The contact between each contact surface 125 and the everting portion 33 of the tube structure 17 assists in achieving wetting out of the layer of resin absorbent material (fibreglass fabric) before it is presented to the interior surface 13 of the pipeline 15. This is because the contact surfaces 125 assist in spreading the resin and driving it into the fibres, as well as removing air from between the fibres, as the everting portion 33 slides over the surfaces. The contact surfaces 125 in effect wipe the everting portion 33 at 114 to work the resin into the resin absorbent material (fibreglass fabric) and also remove air therefrom.

A vent system 140 is provided for removal of air within the volume defined by the space 68 between the trailing end of the body 24 and the everting portion 33 of the tube structure 17.

The vent system 140 comprises the common chamber 103 (functioning as a venting chamber) and a first vent line 141 extending from the volume defined by space 68 to the venting chamber 103. The vent line 141 communicates with the volume defined by space 68 at the upper end thereof. In this embodiment, the vent line 141 has an intake end section 143 which defines a snorkel adapted to locate adjacent the top of the internal surface 13 of the pipe line 15.

The vent system 140 further comprises a second vent line 145 extending from the space 68 to the venting chamber 103. The second vent line 145 has an intake end section 147 configured as a manifold 149 accommodated within the space 68. In this embodiment, the intake manifold 149 is incorporated in the ring structure 120. In this regard, each ring 121 has a hollow section defining an air flow passage which opens onto said contact surface 125 defined by the ring 121 at a plurality of intake ports 153 spaced along a lower section of the ring. With this arrangement, air expelled from the tube structure 17 as it passes over each ring 121 can escape along the second vent line 145 via the ports 153.

In all probability, air passing into chamber 103 by way of vent system 140 will be accompanied by resin originating from space 68. The mixture of vented air and the resin can separate in venting chamber 103. Resin entering the chamber 103 via the vent system 140 accumulates with any resin entering that chamber through leakage from adjacent holding chamber 102, as previously described. The accumulated resin can be recirculated by way of the first return means 110, as previously described. Air entering the vent chamber 103 is vented to atmosphere.

As previously mentioned, the installation structure 20 is of a articulated construction, comprising three modules 21, 22, 23 pivotally connected one to another by rigid links 25. The articulated construction facilitates entry of the installation structure 20 into a pipeline via an entry pit, and also removal via an exit pit.

The second module 22 is disposed at the leading end of the installation structure 20 and comprises a brake sled 160. The brake sled 160 is adapted to frictionally engage the interior surface 13 of the pipeline 15 so as to provide a retarding force for selectively retarding the rate at which the installation structure 20 advances along the conduit 15 under the influence of fluid pressure applied through the everting tube structure 17. The retarding force can be selectively varied by regulating the extent of frictional engagement with the interior surface of the pipeline 15. The brake sled 160 comprises skid members 161 each adapted to be located in sliding engagement with the interior surface 13 of the pipeline 15. The skid members 161 function as the base of the brake sled and travel along the bottom section of the pipeline 15. Further skid members 163 are provided for engaging an opposed section of the pipeline, and an adjustment mechanism 165 is provided for selectively varying the positions of the skid members 161, 163 relative to each other and therefore the frictional forces by which the skid members engage the interior surface of the pipeline.

The rigid connection between adjacent modules 21, 22, and 23 provided by links 25 ensure that braking forces initiated by the second module 22 can be transferred to the other modules 21, 23 and also that towing forces can be transmitted between the modules.

The third module 23, which is intermediate the first and second modules 21, 22, incorporates rollers 170 for rolling engagement with the pipeline 15 at circumferentially spaced locations, thereby to prevent “jack-knifing” or excessive lateral deflection of the installation structure 20 when under braking conditions.

While not shown in the drawings, the second and third modules may incorporate various devices for monitoring and controlling operation of the installation structure 20. Such devices may include cameras, telemetry devices and data logging systems.

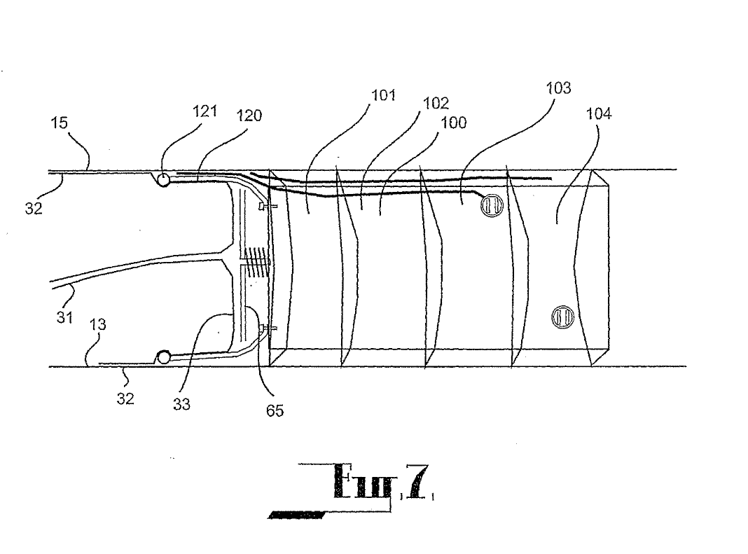

Referring now to FIG. 7, there is shown apparatus according to a second embodiment. The apparatus is similar in many respects to the apparatus 10 according to the first embodiment and so corresponding reference numerals are used to identify corresponding parts. In this embodiment, the ring structure 120 comprises only one ring 121.

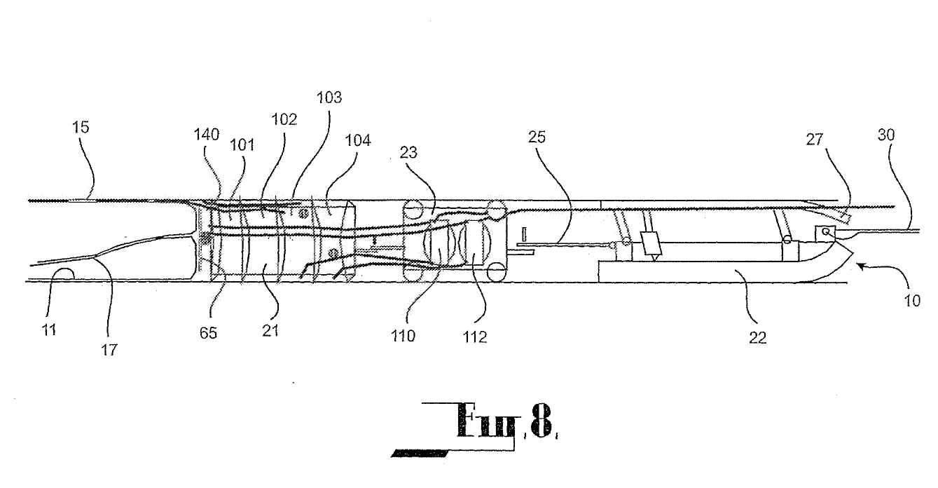

Referring now to FIG. 8, there is shown apparatus which is a variation of the apparatus 10 according to the first embodiment. The apparatus shown is similar in many respects to the apparatus 10 according to the first embodiment and so corresponding reference numerals are used to identify corresponding parts. The variation involves the omission of the ring structure of the first embodiment. The variation utilises the air venting and resin collection systems described in relation to the first embodiment. Rather than communicating with a manifold incorporated in the ring structure utilised in the first embodiment, the second vent line in the variant may communicate with the space in any other appropriate way, such as via a dedicated manifold located in the space,

It should be appreciated that the scope of the invention is not limited to the scope of the various embodiments described.

Throughout the specification, unless the context requires otherwise, the word “comprise” or variations such as “comprises” or “comprising”, will be understood to imply the inclusion of a stated integer or group of integers but not the exclusion of any other integer or group of integers.

1. Apparatus for lining an internal surface of a conduit, the apparatus comprising a body having a portion for confronting an everting tube structure to in combination with an everting portion of the tube structure define a space within the conduit for receiving an agent material delivered into the space, and means presenting a contact surface against which the everting portion engages as it moves towards the internal surface of the conduit.

2. Apparatus according to claim 1 wherein the contact surface extends entirely around the everting portion of the tube structure.

3. Apparatus according to claim 1 wherein the contact surface is defined by a structure defining an opening through which the everting portion of the tube structure passes in sliding contact therewith.

4. Apparatus according to claim 3 wherein the structure defines at least one further opening and contact surface.

5. Apparatus according to claim 3 wherein the structure comprises a ring defining the at least one of the at least one further opening and the associated contact surface.

6. Apparatus according to claim 3, wherein the structure further comprises a support for supporting the or each ring.

7. Apparatus according to claim 1 wherein the or each opening corresponds in shape to the cross-sectional shape of the conduit.

8. Apparatus according to claim 1 wherein the contact surface is arcuate in cross-section.

9. Apparatus according to claim 3 wherein at least one of the at least one further opening is spaced from said portion of the body.

10. Apparatus according to claim 3 wherein the or each opening is of a size smaller than the size of the approaching everting portion of the tube structure to thus cause the everting portion to turn inwardly in order to pass through the opening.

11. Apparatus according to claim 1 wherein eversion of the tube structure creates an inner tube portion, an outer tube portion, and an everting portion extending therebetween.

12. Apparatus according to claim 11 wherein an inflation chamber is defined within the tube everted structure, whereby an inflation fluid introduced into the inflation chamber can urge the everted tube structure outwardly in order to position it in contact with the internal surface of the conduit and wherein the combination of the inflation pressure and the everting portion of the tube structure turningly inwardly in order to pass through the opening in the structure defining the surface causes an adjacent section of the everting portion to expand outwardly.

13. Apparatus according to claim 1 wherein the agent material comprises a curable resin.

14. Apparatus according to claim 13 wherein the tube structure comprises a layer of resin absorbent material.

15. Apparatus according to claim 1 further comprising a vent system for removal of air from within said space.

16. Apparatus according to claim 15 wherein the vent system comprises a venting path extending from said space.

17. Apparatus according to claim 16 wherein the venting path comprises a first vent line having an intake end section adapted to locate between the internal surface of the conduit and the everting tube.

18. Apparatus according to claim 17 wherein the venting path comprises a second vent line.

19. Apparatus according to claim 18 wherein the second vent line incorporates an intake manifold section accommodated in said space, the intake manifold section having a plurality of intake ports opening onto said space.

20. Apparatus according to claim 19 wherein the intake manifold section is incorporated in at least one of the rings.

21. Apparatus according to claim 15 wherein the vent system further comprises a chamber functioning as a venting chamber with which the venting path communicates.

22. Apparatus according to claim 21 further comprising means for returning agent material separated and collected within the venting chamber to the space.

23. Apparatus according to claim 22 wherein the means for returning agent material collected in the venting chamber comprises a first return line and a first pump.

24. Apparatus according to claim 23 wherein the pump is operable in response to a prescribed quantity of agent material being collected in the venting chamber.

25. Apparatus according to claim 1 wherein the body comprises a first seal for sliding engagement with the internal surface of the conduit, the first seal confronting the space, and a holding chamber adjacent the trailing end of the body, one end of the holding chamber being defined by the first seal, the holding chamber applying agent material contained therein to the internal surface of the conduit.

26. Apparatus according to claim 25 wherein the other end of the holding chamber is defined by a second seal for sliding engagement with the internal surface of the conduit.

27. Apparatus according to claim 25 wherein the body comprises one or more further holding chambers disposed one adjacent another with respective sliding seals separating adjacent chambers.

28. Apparatus according to claim 21 further comprising an accumulation chamber for collecting material migrating from the space.

29. Apparatus according to claim 28 wherein the chamber functioning as the venting chamber also functions as the accumulation chamber thereby providing a common chamber.

30. Apparatus according to claim 29 wherein the common chamber is located ahead of the series of holding chambers.

31. Apparatus according to claim 29 wherein the common chamber is defined between the respective sliding seal of an adjacent holding chamber and a further sliding seal provided on the body.

32. Apparatus according to claim 28 wherein a further accumulation chamber is provided for collecting any agent material migrating from the common chamber.

33. Apparatus according to claim 32 further comprising a return means for returning the collected material.

34. Apparatus according to claim 33 wherein the means for returning agent material collected in the further accumulation chamber comprises a second return line and a second pump.

35. Apparatus according to claim 24 wherein the second pump is operable in response to a prescribed quantity of agent material being collected in the further accumulation chamber.

36. Apparatus according to claim 1 wherein the apparatus further comprises an installation structure adapted to be conveyed along the conduit.

37. Apparatus according to claim 36 wherein the installation structure is of articulated construction, comprising at least two modules pivotally connected together by a rigid link extending therebetween, wherein a first one of the modules comprises said body.

38. Apparatus according to claim 37 wherein a second one of the modules comprises means for applying a retarding force for controlling the rate of advancement of the installation structure along the conduit.

39. Apparatus according to claim 38 wherein the second module comprises a brake sled for friction engagement with the internal surface of the conduit.

40. Apparatus according to claim 39 further comprising means for selectively varying frictional engagement between the brake sled and the internal surface of the conduit.

41. Apparatus according to claim 37 wherein a third one of the modules in disposed between the first and second modules, whereby the three modules are linked in series one to another with adjacent modules being interconnected for articulation therebetween and also for transmission of forces therebetween.

42. Apparatus according to claim 41 wherein the second module comprising the brake sled constitutes the leading module (with respect to the direction of travel of the installation structure along the conduit), and the third module incorporate means for rolling engagement with the internal surface of the conduit.

43. (canceled)

44. A method of lining the internal surface of a conduit using a tube structure, the method comprising:
everting the tube structure to provide an inner tube portion, an outer tube portion and an everting portion therebetween;
exposing the everting potion to an agent material contained in a space confronting the everting portion; and
contacting the everting portion with a contact surface as it moves towards the internal surface of the conduit.

45. The method of lining the internal surface of a conduit using a tube structure according to claim 44,
wherein the contacting step comprises passing the everting portion through an opening defined by means presenting a contact surface against which the everting portion is in sliding contact as it passes through the opening.

46. Apparatus for lining an internal surface of a conduit, comprising a body having a trailing end for confronting an everting tube structure to in combination with an everting portion of the tube structure define a space with the conduit for receiving an agent material delivered into the space, an accumulation chamber for collecting material migrating from the space, and means for returning agent material collected within the accumulation chamber to the space.

47-49. (canceled)
